(19) United States
(12) Patent Application Publication
(10) Pub. No.: US 2018/0059803 A1
(43) Pub. Date: Mar. 1, 2018

(54) Keyboard

(71) Applicant: Aleksandr Anikejenko, Kozyn (UA)

(72) Inventor: Aleksandr Anikejenko, Kozyn (UA)

(21) Appl. No.: 15/189,068

(22) Filed: Aug. 29, 2016

(51) Int. Cl. G06F 3/023; G06F 3/02

(52) U.S. Cl. CPC G06F 3/0238; G06F 3/021

(57) ABSTRACT

The present invention provides a keyboard with logically coupled keys in groups for fast typing by lighting the keys in different colors and with the possibility to change light intensity. The keyboard according to the present invention comprising microcontroller, plurality of light sources placed in the keys, light sensor, pressure sensor, signal data converter and is functionally connected to the processing device. A personal computer, laptop, tablet and etc. can be used as a processing device. The keyboard according to the present invention brings in advantages of low cost, easy use and training of good typing skills.

### FIELD OF THE INVENTION

The present invention relates generally to lighting control for keyboards, more particularly to dynamic and individual control of light of the grouped keys, and dynamic adjust of the light intensity both individually and automatically.

### BACKGROUND OF THE INVENTION

In the early stage of computer development, the keyboard had been a fundamental input device. Although the computer has progressed tremendously, the keyboard is still not far away from the prototype until now. However, some manufacturers had developed self-luminous keyboards to convenience using the keyboard in a dim environment or provide a gorgeous and colourful effect. Now, the self-luminous keyboards are familiar to people and available in the market. Generally, LED is used as the light source in the very limited space of a keyboard.

Computing systems utilizing a keyboard or keypad as a peripheral device may incorporate a backlight. The backlight may facilitate use of the keyboard in low light environments.

U.S. Pat. No. 8,358,274 disclosed a “Control method for generating varying coloured lights in keyboard and self-luminous keyboard for realizing the same method”, wherein self-luminous keyboard for realizing the control method comprises a casing, a circuit board arranged inside the casing, a key unit pressed by a user to trigger the circuit board to generate a keying signal, and a backlight unit arranged below the key unit. The backlight unit contains several light-emitting element groups respectively emitting different colors of lights. The self-luminous keyboard further comprises a memory unit storing a driving signal table and a microcontroller unit obtaining the keying signals. The driving signal table contains a plurality of backlight driving signals determining the brightness of the light-emitting element groups. The self-luminous keyboard can realize the two embodiments of the control method mentioned above. When the user presses keys, the microcontroller determines the brightness of each light-emitting element group of the backlight unit according to the keying signals and the driving signal table. Thus, the backlight unit provides the lights of different colors corresponding to different keys. Alternatively, the microcontroller unit detects the generation of a keying signal and then sequentially reads the backlight driving signals from the memory unit and then sequentially outputs the backlight driving signals to the backlight unit. The backlight unit presents the sequential shift of the colored lights. Further, the user can use software to write a new driving signal table to the memory unit and renew the relationship between the keys and the colors of lights.

Meanwhile there is a problem of learning fast typing using known keyboards. For this purpose, a program for training fast (touch) typing on the keyboard is used. Touch typing is based on the fact that defined area (group) of keys is fixed to the each finger. The whole learning process is lead to training of the fingers muscle memory. Regular training (preferably 2-3 times a day), will promote fast typing with ten fingers without looking at the keyboard.

However, the use of such software on a standard keyboard is not effective. As the keys have the same color.

Usage of such software on the U.S. Pat. No. 8,358,274 keyboard is not enough efficient.

There is a need to create a keyboard in which user, in sole discretion, may change the lighting color of key surfaces within each group.

### SUMMARY OF THE INVENTION

In accordance with the invention, a keyboard is provided wherein:

keys logically coupled in groups for fast (touch) typing by marking (lighting) the keys in different colors and with the possibility to change light intensity from minimum to maximum and vice versa, when the key is pressed;

light intensity and/or light color is changed by pressing the key;

possibility to save light combinations of key groups for each user;

in accordance with room brightness, automatic light brightness level is changed.

### BRIEF DESCRIPTION OF THE DRAWINGS

FIG. 1 illustrates an exemplary keyboard according to the present invention.

FIG. 1A-1I illustrates a keyboard with separated key groups according to the present invention.

FIG. 2 illustrates a principle diagram of the keyboard according to the present invention.

### DETAILED DESCRIPTION

Reference will now be made to the drawings to describe the keyboard which illuminates with different color hues in accordance with functions according to the present invention in detail.

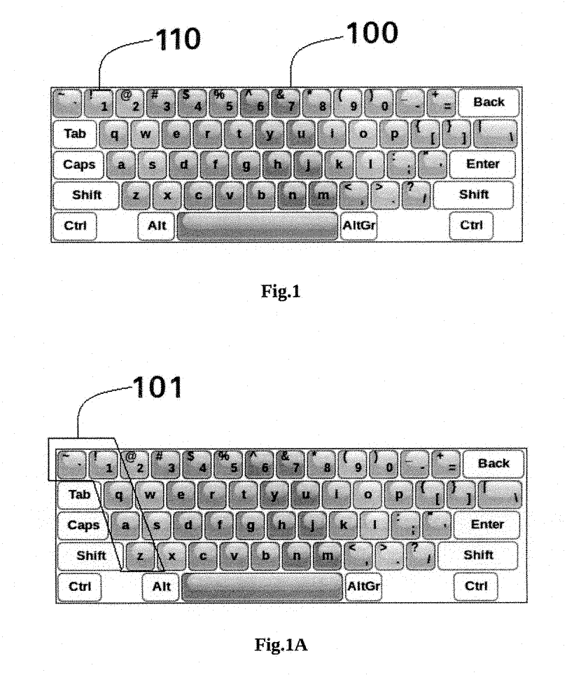

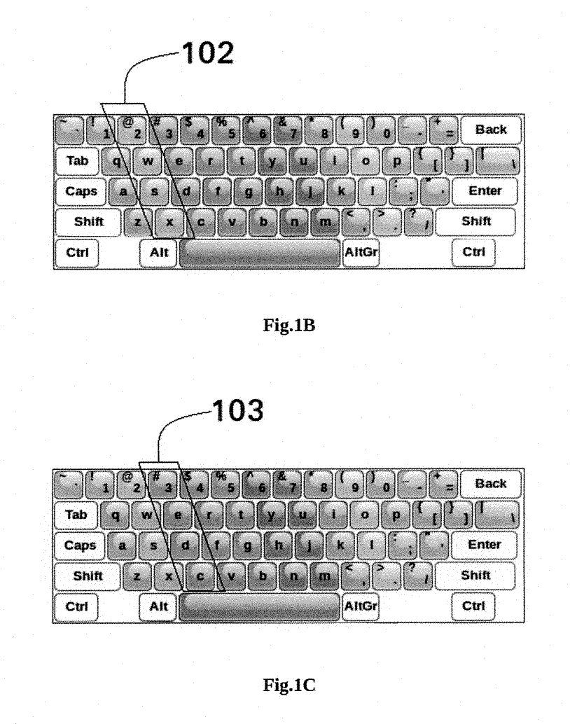

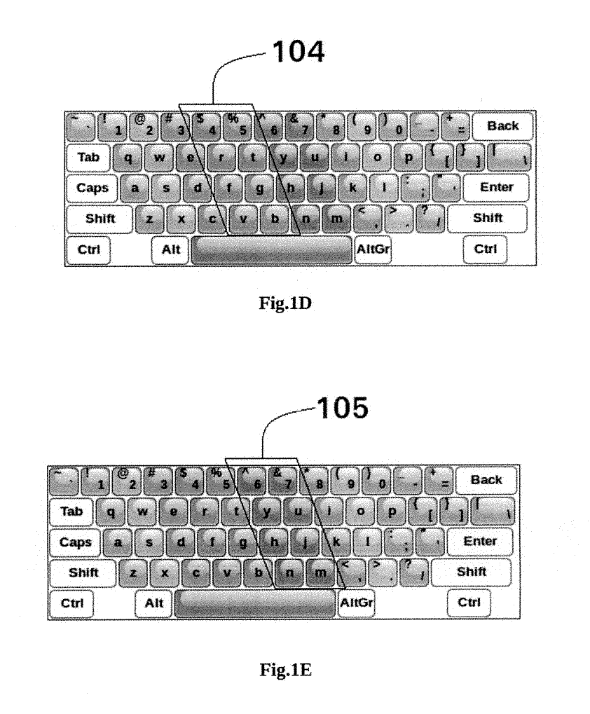

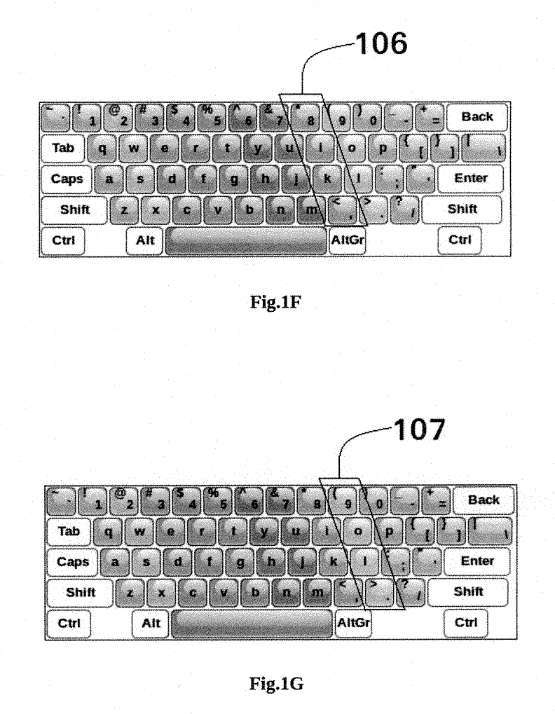

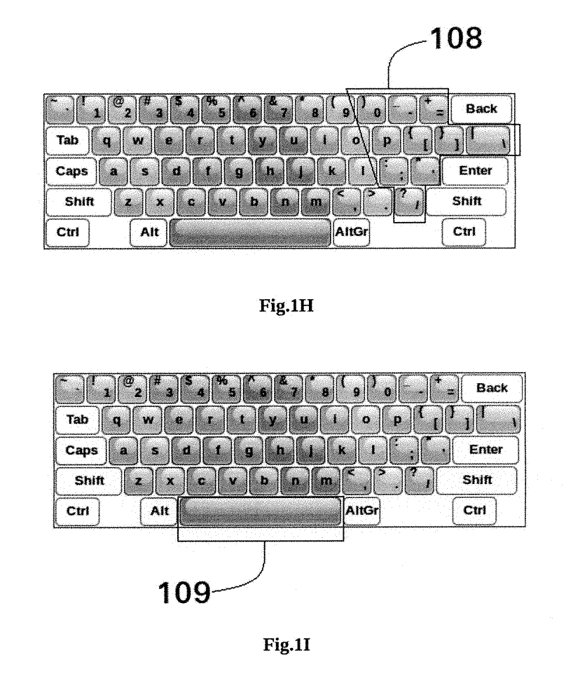

The keyboard 100 as illustrated in FIG. 1 is a Dvorak type wireless mini-keyboard, however, the multi-hues LED illuminated keyboard according to the present invention is not limited to this type of keyboard, any computer used keyboard is applicable, as well as a notebook keyboard or a wired mini-keyboard. The Dvorak type wire or wireless mini-keyboard is convenient for training. The Qwerty type wireless mini-keyboard also can be used. The last one is convenient for movement and has a key arrangement, which includes 78~82 keys in total.

The keys 110 are made from transparent or translucent material, wherein light can be LED, liquid crystal, electroluminescent, laser, neon.

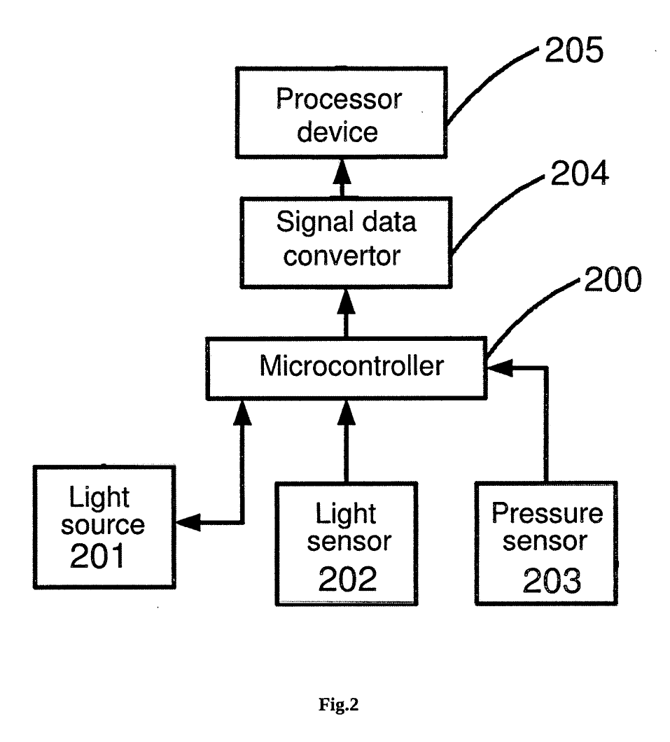

The keyboard 100 with such keys as illustrated in FIG. 2 is comprising microcontroller 200, light source 201, light sensor 202, pressure sensor 203, signal data converter 204. The keyboard is functionally connected to the processing device 205.

A personal computer, laptop, tablet and etc. can be used as a processing device. Under the processing device in this case is meant an external to the keyboard apparatus having in its structure processor, microcontroller, or any other data processing device. The keyboard according to the present invention is designed to exchange signals with the external processing device.

The microcontroller is an microcontroller normally used in an existing computer-used keyboard.

The microcontroller 200 is designed to vary light intensity and color of the plurality of light sources of keys of one group, and to save and reproduce combinations of light intensity and color of the plurality of light sources of keys of one group for every user.

Generally, the light sensor 202 is mounted on the keyboard 100 case. In accordance with room brightness, said sensor 202 is designed to change light brightness level automatically.

The pressure sensor 203 may be mounted in one of the keys. For example, in Tab key. The pressure sensor 203 is designed to change light brightness level. The user makes a single click on specified key, to change light brightness level. Pressing signal is transmitted to the microcontroller 200, which generates a corresponding signal for decrease or increase of light brightness sources.

The signal data converter 204 is designed to convert signals from the microcontroller 200 in signals, that will be transmitted to the processing device 205, and reverse conversion of signals from the processing device 205 in signals, that will be transmitted to the microcontroller 200.

The signal data converter 204 exchanges data between the keyboard 100 and the processing device 205 via wire or wireless connection.

Key light may be switched on automatically during power supply (computer booting) manually.

Moreover, user can independently change light color of keys working surface within each group 101-109, selecting appropriate settings in a personal computer. In pursuing these aims, the user uses a special program that is automatically installed on computer during the first keyboard connection. Switching to configuration mode for change of color or intensity of keys light via main menu program.

The present keyboard is used as follows. The user places each finger of the left and right hand above groups, that have different light, namely left-hand fingers should be placed above ASDF keys and right-hand fingers—above JKL; keys.

The key A is positioned in group of keys 101 that for example may have light of red color, as shown in FIG. 1A.

The key S is positioned in group of keys 102 that for example may have light of yellow color, as shown in FIG. 1B.

The key D is positioned in group of keys 103 that for example may have light of green color, as shown in FIG. 1C.

The key F is positioned in group of keys 104 that for example may have light of blue color, as shown in FIG. 1D.

The key J is positioned in group of keys 105 that for example may have light of dark blue color, as shown in FIG. 1E.

The key K is positioned in group of keys 106 that for example may have light of green color, as shown in FIG. 1F.

The key L is positioned in group of keys 107 that for example may have light of yellow color, as shown in FIG. 1G.

The key 0, P, ; , / and others are positioned in group of keys 108 that for example may have light of red color, as shown in FIG. 1H.

The key SPACEBAR is positioned in group of keys 109 that for example may have light of violet color, as shown in FIG. 1I.

The user presses with a finger on a relevant key, which is positioned in an area that corresponds to this finger, when typing text or inputting other information. Also, the user individually may change light color and intensity (brightness) of keys working surface.

The keyboard is useful for:

children—typing and studying at the same time with a computer will be an exciting game for them;

students—the keyboard will be helpful in everyday activities;

IT specialists and Gamers—it will help in the fast identification of the function keys;

ordinary users—will become more advanced;

creative people—can define their own way of expression;

computer makers—this keyboard can help them to differentiate from other manufacturers.

A keyboard production does not require expensive technical solutions and can be carried out in conditions of modern production of electronic devices using the existing equipment and materials.

It should be noted that the above embodiments are merely provided for describing the technical solutions of the present invention, but not intended to limit the present invention. To persons of ordinary skill in the art, various modifications and changes can be made to the present invention. Any modification, equivalent replacement, and improvement made by persons of ordinary skill in the art without departing from the spirit of the present invention shall fall within the protection scope.

1. A keyboard comprising:
a plurality of keys logically coupled in groups;
a plurality of light sources placed in the keys, to provide light to the grouped keys;
a light sensor mounted on the keyboard case, or a pressure sensor mounted at least in one of the keys;
a keyboard controller coupled to the plurality of keys, light sources and pressure sensor wherein said microcontroller functionally coupled to the light sensor and pressure sensor;
said microcontroller being configured to vary light intensity and color of the plurality of light sources of keys of one group;
said microcontroller being configured to save and reproduce combinations of light intensity and color of the plurality of light sources of keys of one group for every user.
